(19) United States
(12) Patent Application Publication
(10) Pub. No.: US 2015/0256765 A1
(43) Pub. Date: Sep. 10, 2015

(54) CHARGE INJECTION COMPENSATION FOR DIGITAL RADIOGRAPHIC DETECTORS

(71) Applicant: Carestream Health, Inc., Rochester, NY (US)

(72) Inventors: Mark E. Shafer, Fairport, NY (US); Gregory N. Heiler, Hilton, NY (US); Gordon Geisbuesch, Fairport, NY (US); Timothy J. Tredwell, Fairport, NY (US)

(21) Appl. No.: 14/430,242

(22) PCT Filed: Oct. 29, 2013
(86) PCT No.: PCT/US2013/067234

§ 371 Date: Mar. 23, 2015

Related U.S. Application Data
(60) Provisional application No. 61/720,092, filed on Oct. 30, 2012.

(51) Int. Cl. H04N 5/32; H04N 5/3745; G01T 1/24

(52) U.S. Cl. CPC H04N 5/32; G01T 1/247; H04N 5/3745

(57) ABSTRACT

Embodiments of DR detector methods and/or apparatus for charge compensation can provide charge injection and/or at least one charge injection circuit that can temporally cancel charge injection to readout circuits resulting from positive (and/or negative) transitions of gate lines for pixel signal readout. In certain exemplary embodiments, DR detector imaging array methods and/or apparatus can provide variable charge injection levels (e.g., voltage or capacitance), variable Tau (e.g., resistance or capacitance), and/or multi-charge injection with staggered timing (e.g., using voltage and/or capacitance steps). In certain exemplary embodiments, DR detector imaging array methods and/or apparatus can provide charge injection compensation on ROIC on mask block basis. In exemplary embodiments, DR detector imaging array methods and/or apparatus can provide voltage reset off-set in readout circuits (e.g., ROICs).

### FIELD OF THE INVENTION

The application generally relates to digital x-ray imaging methods/system, and more specifically, to methods and/or systems for operations and/or readout of Digital Radiographic (DR) Detectors.

### BACKGROUND

Stationary radiographic imaging equipment are employed in medical facilities (e.g., in a radiological department) to capture medical x-ray images on x-ray detector. Mobile carts can include an x-ray source used to capture (e.g., digital) x-ray images on x-ray detector. Such medical x-ray images can be captured using various techniques such as computed radiography (CR) and digital radiography (DR) in radiographic detectors.

A related art digital radiography (DR) imaging panel acquires image data from a scintillating medium using an array of individual sensors, arranged in a row-by-column matrix, in which each sensor provides a single pixel of image data. Each pixel generally includes a photosensor and a switching element that can be arranged in a co-planar or a vertically integrated manner, as is generally known in the art. In these imaging devices, hydrogenated amorphous silicon (a-Si:H) is commonly used to form the photodiode and the thin-film transistor switch needed for each pixel. In one known imaging arrangement, a frontplane has an array of photosensitive elements, and a backplane has an array of thin-film transistor (TFT) switches.

However, there is a need for improvements in the consistency and/or quality of medical x-ray images, particularly when obtained by an x-ray apparatus designed to operate with a-Si DR x-ray detectors.

### SUMMARY OF THE INVENTION

An aspect of this application is to advance the art of medical digital radiography.

Another aspect of this application is to address, in whole or in part, at least the foregoing and other deficiencies in the related art.

It is another aspect of this application to provide, in whole or in part, at least the advantages described herein.

An aspect of this application to is to provide methods and/or apparatus to address and/or reduce disadvantages caused by the use of portable (e.g., wireless) digital radiography (DR) detectors and/or radiography imaging apparatus using the same.

An aspect of this application is to provide methods and/or apparatus that can charge compensation methods and/or apparatus for DR detectors.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings.

The elements of the drawings are not necessarily to scale relative to each other.

FIG. 1 is a schematic diagram that shows a DR detector Panel Circuit according to the application.

FIGS. 2A and 2B are diagrams that shows a perspective view of an exemplary pixel and a cross-sectional view of a exemplary pixel for use in a DR detector according to the application.

FIG. 3 is a diagram that shows exemplary TFT capacitive coupling for an exemplary pixel according to the application.

FIG. 4 is a diagram that shows an exemplary circuit illustrating charge injection according to the application.

FIG. 5 is a diagram that shows an exemplary TFT charge injection readout relationship according to embodiments of the application.

FIG. 6 is a diagram illustrating exemplary ROIC operating regions and/or output limits according to the application.

FIG. 7 is a diagram illustrating exemplary ROIC output after gate line charge injection according to the application.

FIG. 8 is a diagram that shows an exemplary dark image from a DR detector according to an embodiment of the application.

FIG. 9 is a diagram that shows a charge injection compensation circuit embodiment connected to a data line adjacent a ROIC according to the application.

FIG. 10 is a diagram illustrating exemplary ROIC output with gate line charge injection compensation according to the application.

FIGS. 11A-11B are diagrams that shows a variable charge injection compensation circuit embodiments according to the application.

FIG. 12 is a diagram illustrating exemplary ROIC output with variable charge injection compensation according to exemplary embodiments of the application.

FIG. 13 is a diagram that shows an exemplary CSA Circuit according to exemplary embodiments of the application.

FIG. 14 is a diagram that shows exemplary CSA circuit operational sequences according to exemplary embodiments of the application.

FIG. 15 is a diagram that shows a perspective view of an exemplary radiographic area detector configured to include rows and columns of detector cells in position to receive X-rays passing through a patient during a radiographic procedure.

### DESCRIPTION OF EXEMPLARY EMBODIMENTS

The following is a description of exemplary embodiments of the invention, examples of which are illustrated in the accompanying drawings. Wherever possible, the same reference numbers will be used throughout the drawings to refer to the same or like parts.

For simplicity and illustrative purposes, principles of the invention are described herein by referring mainly to exemplary embodiments thereof. However, one of ordinary skill in the art would readily recognize that the same principles are equally applicable to, and can be implemented in, all types of radiographic imaging arrays, various types of radiographic imaging apparatus and/or methods for using the same and that any such variations do not depart from the true spirit and scope of the application. Moreover, in the following description, references are made to the accompanying figures, which illustrate specific exemplary embodiments. Electrical, mechanical, logical and structural changes can be made to the embodiments without departing from the spirit and scope of the invention. In addition, while a feature of the invention may have been disclosed with respect to only one of several implementations/embodiments, such feature can be combined with one or more other features of other implementations/embodiments as can be desired and/or advantageous for any given or identifiable function. The following description is, therefore, not to be taken in a limiting sense and the scope of the invention is defined by the appended claims and their equivalents.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. Where they are used, the terms “first”, “second”, and so on, do not necessarily denote any ordinal or priority relation, but may be used for more clearly distinguishing one element or time interval from another.

This application relates to operations and readout of DR detectors. Certain methods and/or apparatus embodiments herein can address the problems or disadvantages associated with gate line induced TFT charge injection and its impact on signal readout. One benefit of this application is to passive pixel panels, utilizing TFT's, in a low dose high speed mode.

In portable (e.g., wireless) DR detectors, when the gate line transitions, charge is injected through the TFT capacitance into the data line, which is connected to the Read Out ASIC's (ROIC) input. This charge injection acts like an offset that reduces the ROIC dynamic range left available to acquire the signal. Additionally, due to the fabrication process mask step and repeat process, TFT parasitic capacitances, hence the level of TFT charge injection may vary across the panel.

Current methods for charge injection compensation involve injecting charge of the opposite polarity into the ROIC Input. An issue with the current method is it effects the ROIC faster than charge injection through the TFT. The circuit time constant (Tau) for gate line transition induced charge injection (e.g., gate line induced TFT charge injection) and the charge injection compensation are significantly different. Thus, the charge injection compensation may drive the ROIC into a non-linear regime, before the TFT charge injection is seen, creating a highly non-linear condition.

Certain exemplary apparatus and/or method embodiments for charge compensation for operations or readouts of Digital Radiography (DR) detectors described in this application can address or maintain the integrity of the signal acquisition (e.g., linearity).

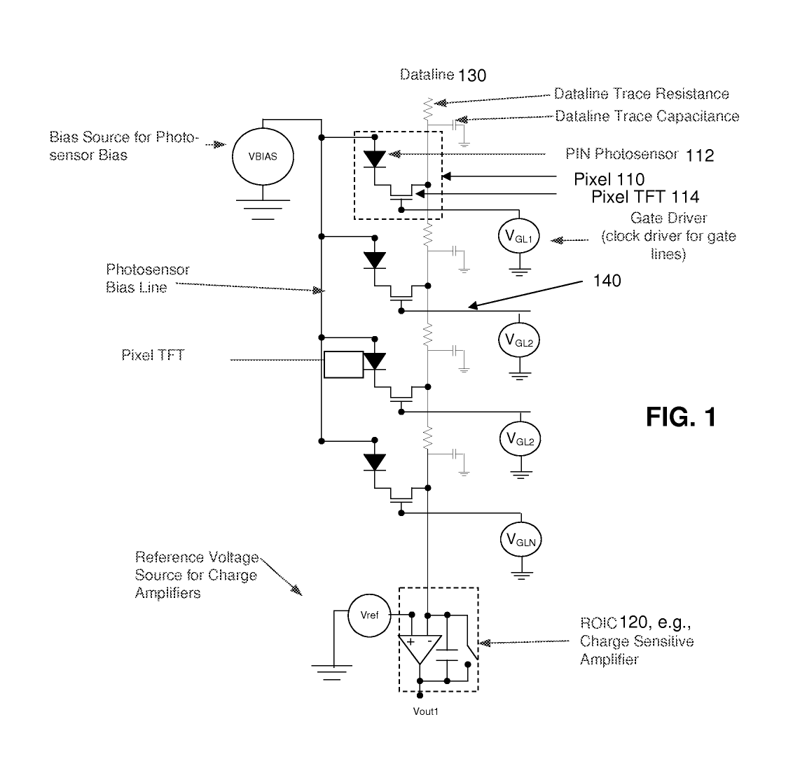

FIG. 1 is a schematic diagram that shows a DR detector Panel Circuit. As shown in FIG. 1, a pixel 110 can include a photosensor 112 and a TFT 114 that can serve as a switch. The signal is captured by the photosensor 112 (e.g., Pin Diode, etc.), the TFT 114 gate is driven high to turn it on, and then a ROIC 120 reads out the signal (e.g., charge).

Depending on at least the architecture, the layout, and the TFT size, there are varying degrees of capacitive coupling between a gate line 140 and a data line 130 in a DR detector. This capacitance can include data line to gate line cross over capacitance (Cₓₒᵥₑᵣ) and the parasitic capacitance through the TFT (C_{TFT}_{_{—}}_{GL-DL).}

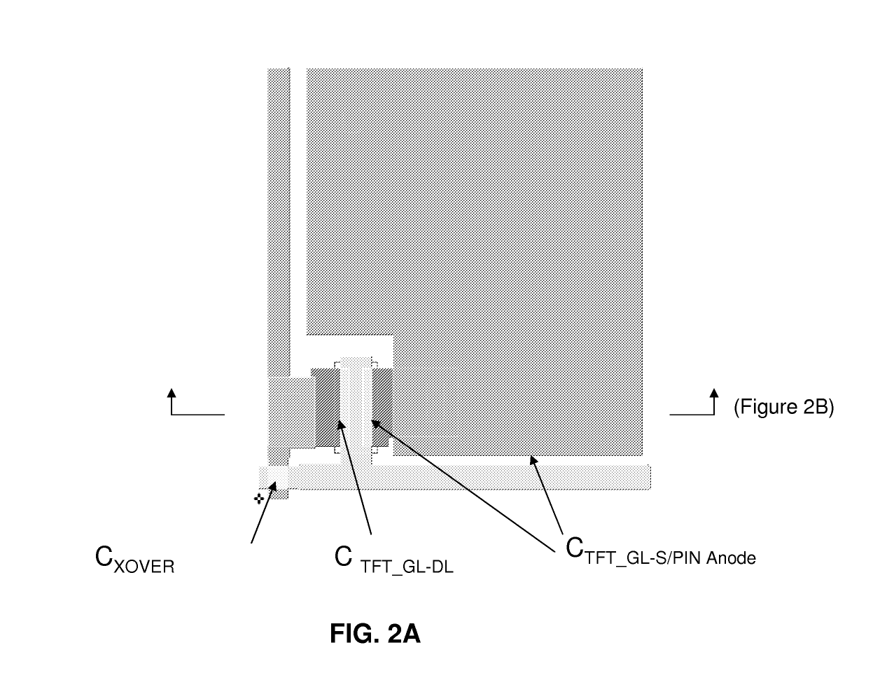

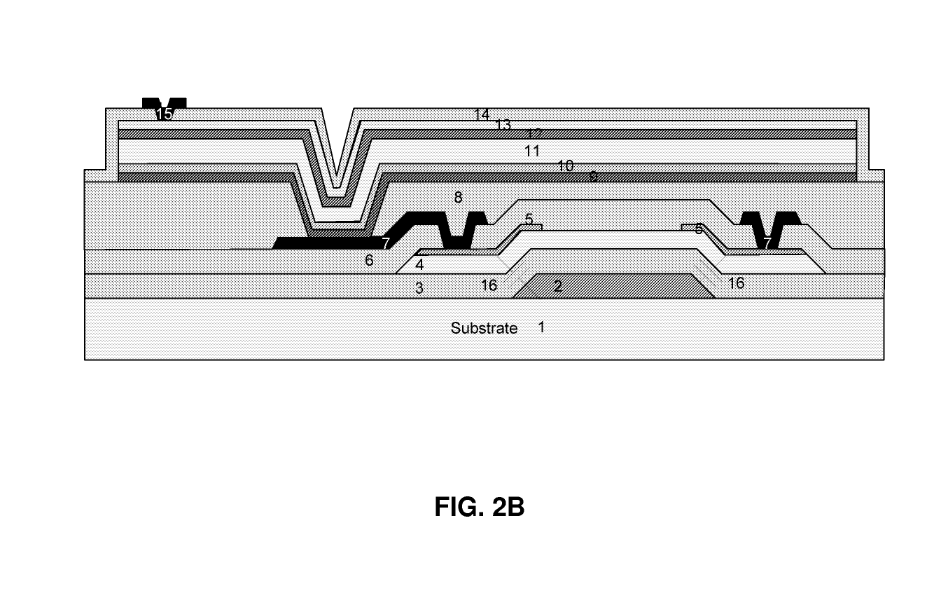

FIGS. 2A and 2B are diagrams that show a perspective view of an exemplary pixel and a cross-sectional view of an exemplary pixel for use in a DR detector. In FIGS. 2A-2B, the coupling capacitance is shown for an exemplary vertically integrated pixel cell. In FIG. 2B, illustrated components of the vertically integrated pixel cell include Gate Line 2, insulator 3,6,8,14, amorphous silicon (a-Si) a-Si:H 4, n+ a-Si:H 5, TFT source/drain metal contacts 7, exemplary sensor layers 9-14 and sensor bias contact 15. A parasitic TFT capacitance is also illustrated.

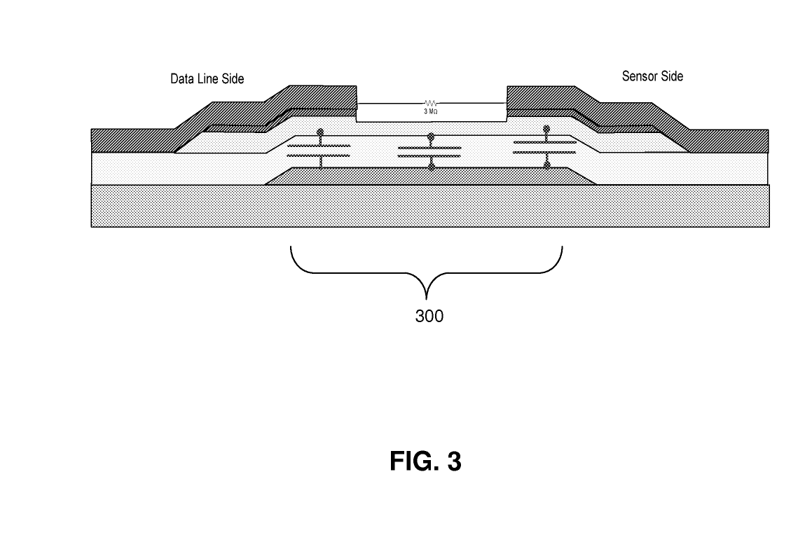

FIG. 3 is a diagram that shows exemplary TFT capacitive coupling for an exemplary pixel. The rising gate line injects charge into the TFT source, drain and can inject into the TFT channel when it's formed. As shown in FIG. 3, charge injected on the sensor side has to go through the switch resistance (i.e. TFT), which can have high resistance resulting in a longer time constant (τ). Thus, part of the charge injected by the rising gate line using exemplary TFT capacitive coupling 300 can be seen very quickly (e.g., at the ROTC) while the remainder can be seen as part of the sensor signal, with a longer time constant.

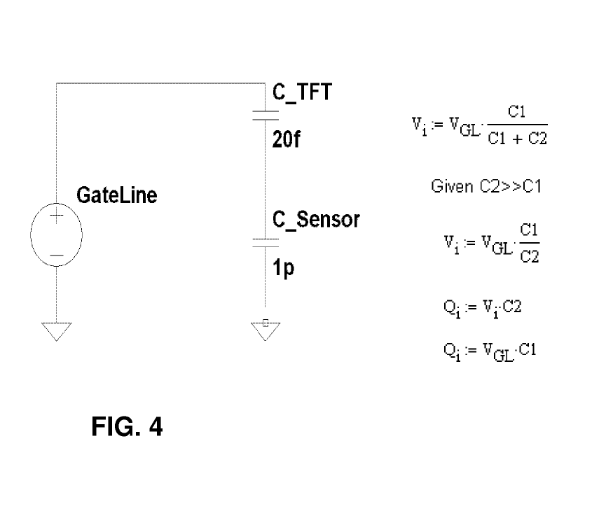

The amount of charge injection can be approximated from the change in voltage and the coupling capacitor. FIG. 4 is a diagram that shows an exemplary circuit illustrating charge injection. Consider the circuit 400 shown in FIG. 4, with features including: a) Gate Line driven from −5v to 20v; b) TFT parasitic capacitance of 20 fF (3 MΩ on resistance); and c) Sensor Capacitance of 1 pF. The amount of charge injection can be approximated by multiplying the voltage step times the parasitic capacitance, which for this case is 0.5 pC. Note that during ROTC (charge sensitive amplifier (CSA)) readout, this charge can be readout slowly due to the high pixel RC time constant.

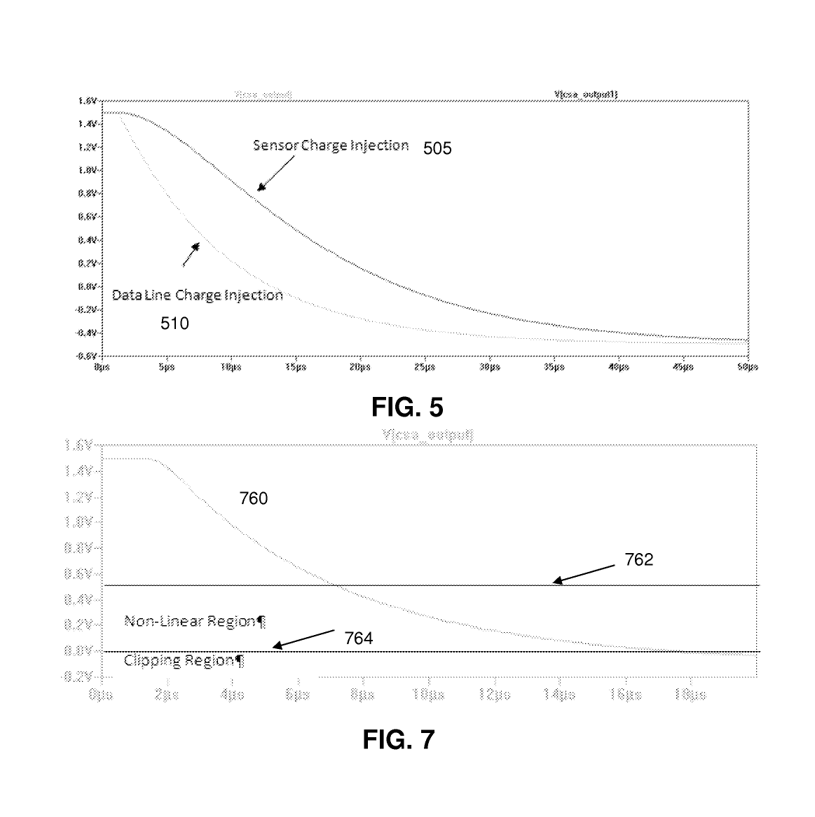

FIG. 5 is a diagram that shows an exemplary TFT charge injection readout relationship between: sensor charge injection vs. data line charge injection. As shown in FIG. 5, a sensor charge injection 505 can be different in at least time, maximum and/or rate relative to a data line charge injection 510.

The input stage of the ROIC can include a charge sensitive amplifier (CSA). A CSA can include an operational amplifier (opamp) with a feedback capacitor (see for example, FIG. 1, panel circuit schematic, ROIC 120). A panel readout process can use a correlated double sample and hold (CDS) method. The CDS method first samples the input, then samples the signal, and then outputs the difference. When charge injection occurs, the CSA drives its output so as to maintain the input voltage. For a positive gate line charge injection, the CSA drives its output negative to compensate. At some point, the output of the CSA can be driven into the non-linear region, resulting in signal distortion.

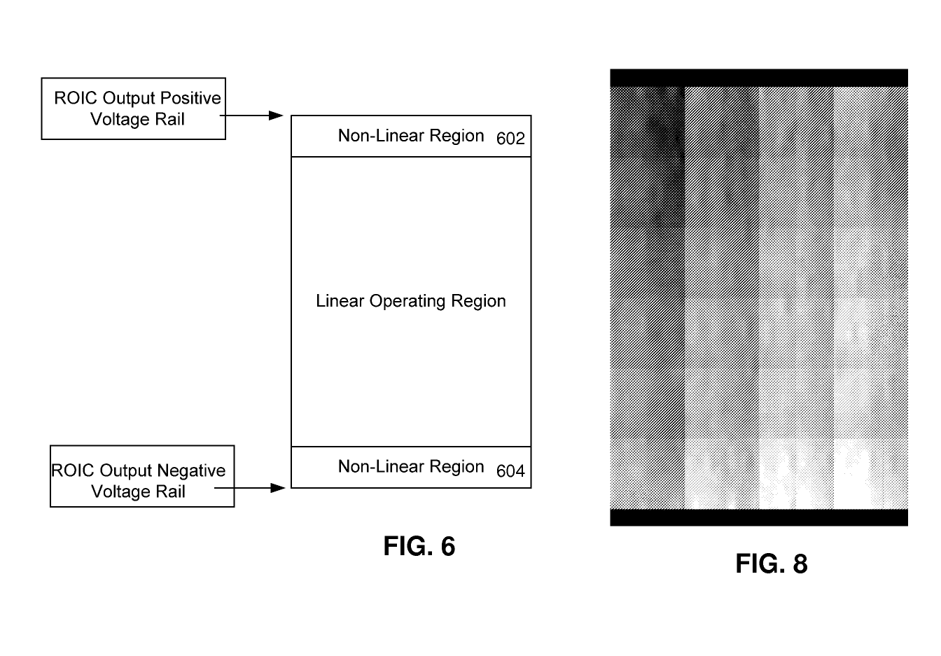

FIG. 6 is a diagram illustrating exemplary ROIC operating regions and/or output limits. As shown in FIG. 6, typically the output of a CSA can not be driven in a linear fashion to the positive rail or the negative rail of the output stage. Usually there is an operating margin 602, 604 (e.g., delta) from the rails required to maintain signal integrity (e.g., no distortion). In a more extreme case, if the signal drives to force the output beyond the power rails, the output simply clips the signal (e.g., at the rail value).

When the positive charge injection from the gate line transition reaches the ROIC, the ROIC output can be driven lower. The higher the gain setting (e.g., low dose modalities) the larger the output transition will be. FIG. 7 is a diagram illustrating exemplary ROIC output after gate line charge injection (high gain mode). As shown in FIG. 7, a modeled ROTC output 760 result, using very basic component models, shows the output can be driven down below the 0.5 volt non-linearity threshold 762 (and event the clipping threshold 764). In reality, at that point, the output 760 would not follow the simulation results, it would show non-linear or clipping behavior.

For certain exemplary embodiments described herein, the capacitive coupling can also depends on the screen alignment (e.g., screen position). On large panels, layers are imaged by using step-and-repeat mask stepping technology, which is common in the semiconductor industry. If the TFT source/drain metal mask alignment is shifted in regards to the gate metal mask, the capacitive coupling from gate-to-source and/or gate-to-drain will change from an ideal alignment case (e.g., and/or previous or later stamped portion of the panel). Hence the charge injection will vary according to the alignment. FIG. 8 is a diagram that shows an exemplary dark image from a DR detector according to an embodiment of the application. As shown in FIG. 8, charge injection variation with mask stepping is shown in the dark image.

Current methods of dealing with the gate line charge injection can include (i) injecting an opposing charge to cancel the gate line charge at the data line at the ROIC or (ii) running the ROIC in lower gains setting so the charge injection does not cause the corresponding output voltage to transgress outside of the linear region of the ROIC (e.g.,, CSA).

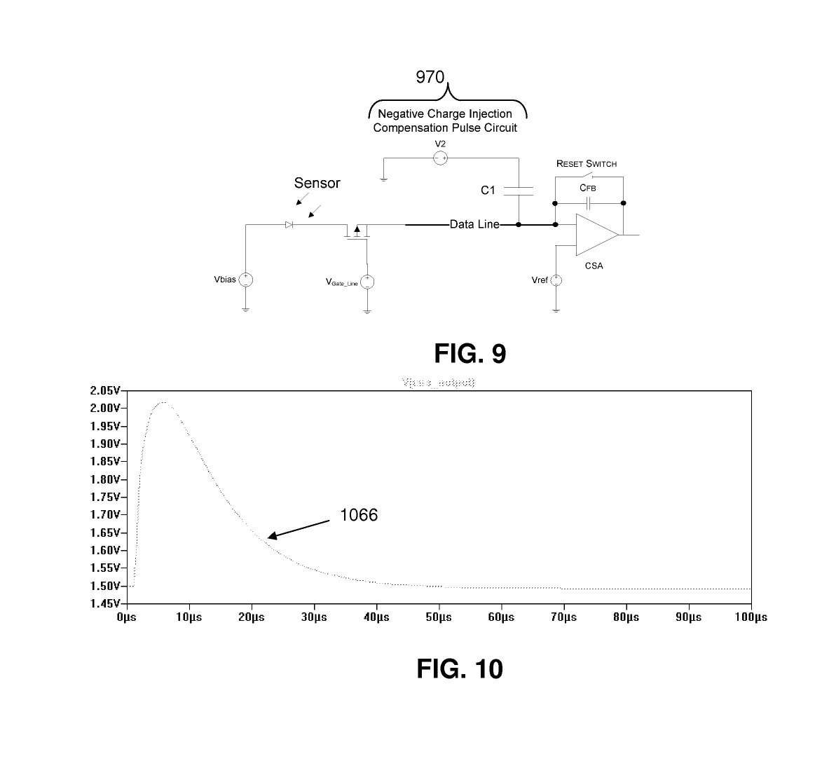

One issue with injecting an opposing charge is that the charge is injected at the ROIC input, and thus the injected charge can be seen by the CSA almost immediately. As described herein, however, charge injection from the gate line transition has at least 2 components, which can include the charge injected into the data line and the charge injected into the sensor. The charge injected into the data line is readout fairly quickly, while the charge injected into the sensor is readout out through the switch (e.g., TFT) resistance, which takes longer. This results in an output positive excursion, which if too large can result in non-linearities (e.g., exceeding device upper rail). FIG. 9 is a diagram that shows a charge injection compensation circuit 970 connected to a data line adjacent a ROIC. This will lead to signal distortion, thus is not an acceptable solution by itself. In addition, it may require a longer line time for the output of the RIC to settle before latching. FIG. 10 is a diagram illustrating exemplary ROIC output with gate line charge injection compensation (e.g., charge injection compensation circuit 970).

Another approach is to simply run the ROIC at a low gain setting, which reduces the output excursion for a given level of charge injection. Running the ROIC in lower gains setting can reduce the chance that the charge injection will cause the corresponding output voltage to transgress outside of the Linear Region of operation for the ROIC. The lower gains setting option can be done with or without charge injection compensation. One disadvantage with this approach is that electronic noise is typically higher at the lower gain settings, which can result in an adverse effect on the signal to noise ratio (SNR). Further, both of these approaches do not address the variable gate line charge injection caused by mask step-n-repeat processes and/or offsets.

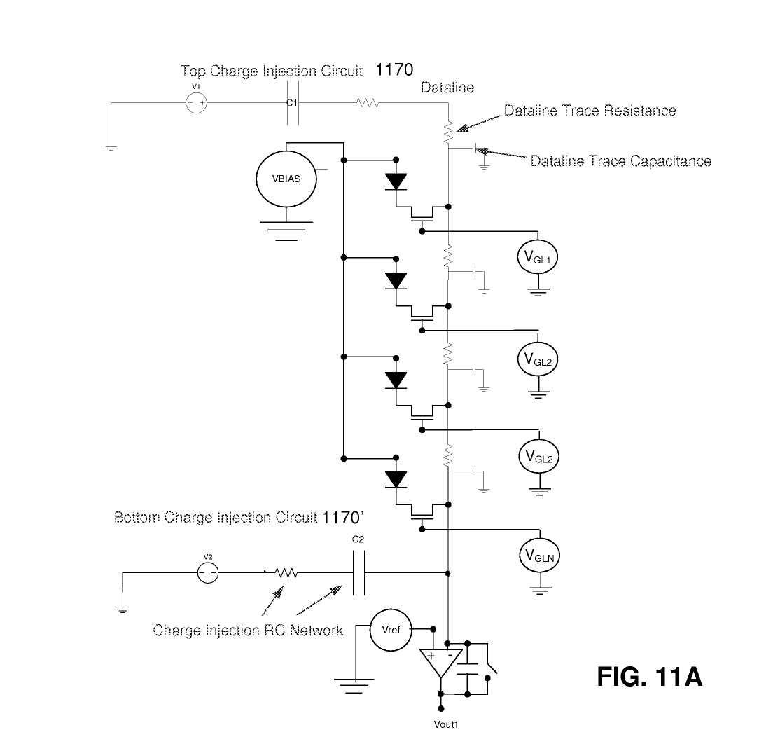

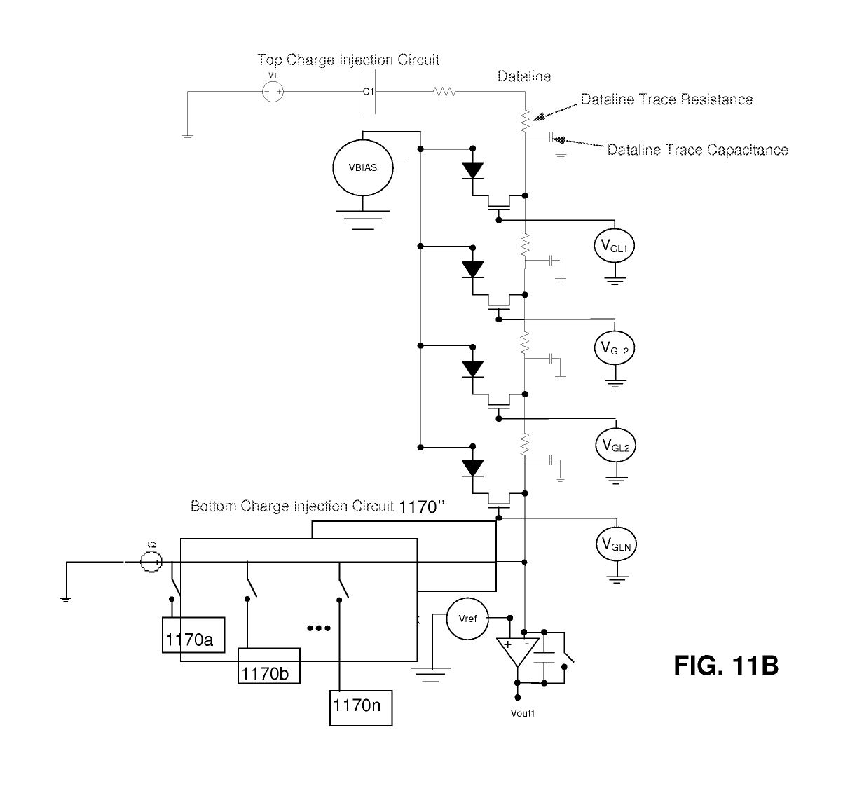

Certain exemplary embodiments of DR detector methods and/or apparatus for charge compensation described herein can provide variable charge injection compensation. FIG. 11A is a diagram that shows a variable charge injection compensation circuit embodiment according to the application. As shown in FIG. 11B, multiple charge injection compensation events can be implemented by one variable charge injection compensation circuit embodiment.

In one embodiment, for certain panel configurations, the plurality of ROICs can be positioned on 1 side of the panel (single sided readout), and first and second charge injection circuits can be used to inject charge on the top and/or bottom of a data line. The amount of charge injection and the timing of the charge injection can be adjusted (e.g., among at least two charge injection circuits) as needed to maintain the ROIC input in the linear region while compensating for the gate line charge injection and reducing or minimizing the perturbation of the ROIC output.

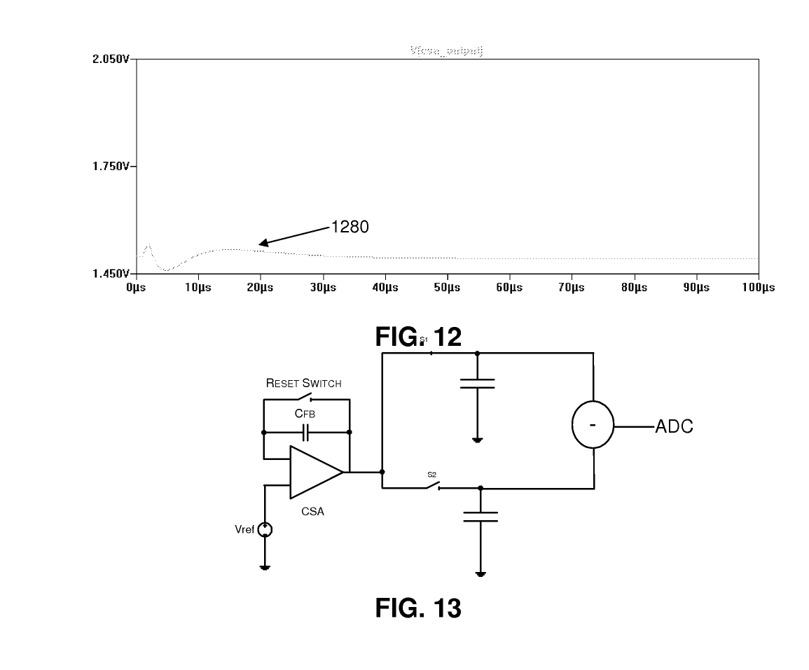

For certain exemplary embodiments, by adjusting the amount of charge injection from at least two (e.g., top and bottom) charge injection circuits, and adjusting the RC network values (e.g., Charge Injection Time Constant), the perturbation to the ROIC output can be reduced or minimized. Thus, the amount of charge injection from a top charge injection circuit 1170 and a bottom charge injection circuit 1170′ can be different. In one embodiment, a controlled negative charge injection can substantially cancel (e.g., tau, timing and/or magnitude) gate line readout (e.g., positive) transition charge injection. As shown in FIG. 11B, multiple charge injection compensation events can be implemented by one variable charge injection compensation circuit 1170″, which can be implemented alone or with additional circuits (e.g., circuit 1170). FIG. 12 is a diagram illustrating exemplary ROIC output with variable charge injection compensation (e.g., charge injection compensation curve 1280).

For the single sided charge injection case, similar compensating results can be achieved by certain exemplary embodiments having multiple charge injection events, with the amount of charge injection and time constants tailored to reduce or minimize the perturbation to the ROIC output. The charge injection circuit may be tailored by adjusting charge injection magnitude (e.g., voltage and/or capacitance) and the time constant (e.g., resistance and capacitance). A single charge injection circuit or multiple charge injection circuits may be used (e.g., selectable by a plurality of switches) to adjust charge injection magnitude (e.g., voltage and/or capacitance) and/or the time constant (e.g., resistance and capacitance). If a single charge injection circuit is used, the desired results may be achieved by stepping the charge injection compensation voltage while optionally modifying the circuit time constant. In one embodiment, at least one charge compensation circuit can include a single charge compensation circuit configured to provide a plurality of variable charge injection delays, where the plurality of variable charge injection delays comprise variable resistance time delays or variable capacitance time delays, where the plurality of variable charge injection delays are selectable by a plurality of switches.

Certain exemplary embodiments can provide the capability for variable panel corrections addressing mask alignment variations. As described herein, the amount of charge injection compensation required can be dependent on mask alignment variations across the panel (see for example, FIG. 8). Charge injection circuit(s) can be integrated into the front end of a ROIC and may be global to all inputs for each mask. Charge injection circuit can be integrated into the front end of a ROIC for a subset of all inputs for a ROIC. In one embodiment, masks are designed on a ROIC boundary, so the charge compensation can be tailored for each ROIC associated with one mask block.

Additionally, the output of a dark frame capture, with the gate line falling transitions outside of the integration time, can be used to measure the gate line charge injection. This measurement, in turn, can be used to derive the charge injection compensation settings. The function to determine the settings can be part of the ROIC or performed externally. The settings could be stored in a registers, so as to allow for automatic charge compensation changes with preset line numbers (e.g., modifications in compensation charge by prescribed panel lines). In one embodiment, the charge compensation changes can be determined to change row-by-row and/or at or within ROIC boundaries (e.g., column by column), where the charge compensation injection can reduce or minimize time and/or magnitude (e.g., of the temporal gate line charge injection). The settings can be determined periodically, repeatedly, or responsive to an operator action.

In one exemplary embodiment, components and/or circuitry implementing charge injection compensation can be formed entirely within a ROIC, partially within a ROIC and partially within an imaging array layout (e.g., using a-Si:H), or entirely within an imaging array layout of a DR detector.

In one exemplary embodiment, components and/or circuitry implementing charge injection compensation can be used to compensate positive gate line transitions, e.g., when a signal accumulation period can be terminated before the gate line is turned off or disabled (e.g., negative gate line transition). Embodiments described herein can address negative charge injection to readout circuits caused by a negative gate line transitions, e.g., when signal accumulation periods include both the gate line enabled and disabled transitions.

In one embodiment, a voltage reset offset can be implemented at the signal sensing circuit (e.g., ROIC, CSA). The input stage of the ROIC typically can include a charge sensitive amplifier (CSA). A CSA includes an opamp with a feedback capacitor. The readout process typically uses a correlated double sample and hold (CDS) method. CDS first samples the input, then samples the signal, and then outputs the difference. Consider the following diagram.

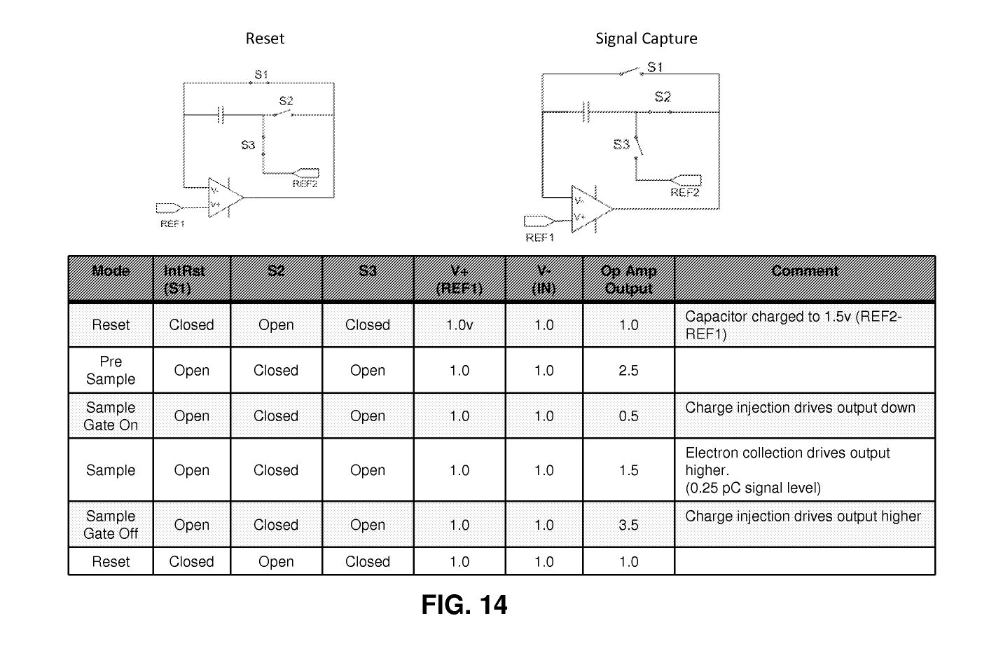

FIG. 13 is a diagram that shows an exemplary CSA Circuit according to exemplary embodiments of the application. When the CSA is initially reset, typically the feedback capacitor (e.g., CFB) is completely discharged, thus has 0 volts across it. Certain exemplary embodiments can provide the capability for an output stage to be reconfigurable to allow the reset operation to establish a non-zero repeatable charge across the feedback capacitor, such than when charge injection occurs, the CSA output is at a higher voltage. In one embodiment, the non-zero repeatable charge across the feedback capacitor can operate to increase the positive gate line charge injection tolerance. FIG. 14 is a diagram that shows exemplary CSA circuit operational sequences according to exemplary embodiments of the application.

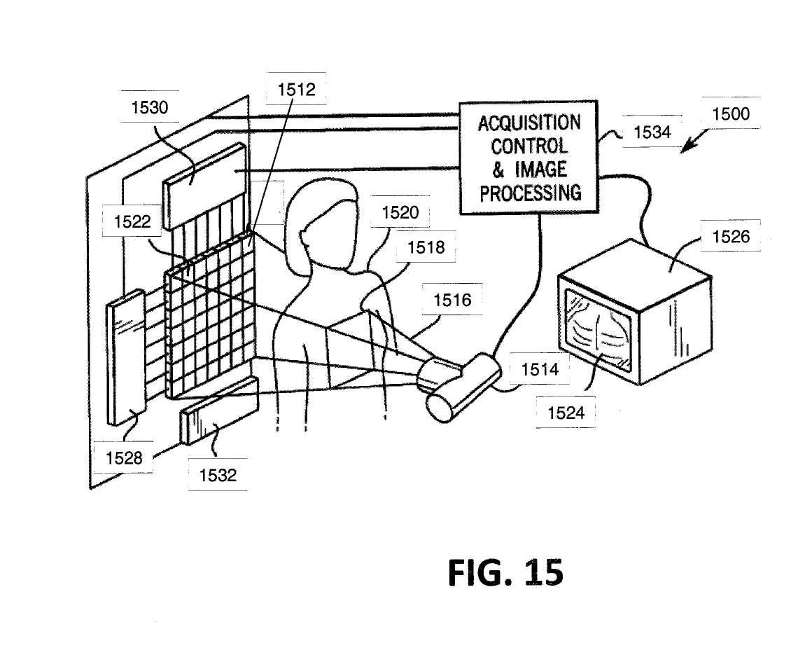

FIG. 15 is a diagram that shows a perspective view of an exemplary radiographic area detector configured to include rows and columns of detector cells in position to receive X-rays passing through a patient during a radiographic procedure. As shown in FIG. 15, an X-ray system 1510 that can use an area array 1512 can include an X-ray tube 1514 collimated to provide an area X-ray beam 1516 passing through an area 1518 of a patient 1520. The beam 1516 can be attenuated along its many rays by the internal structure of the patient 1520 to then be received by the detector array 1512 that can extend generally over a prescribed area (e.g., a plane) perpendicular to the central ray of the X-ray beam 1516 (e.g., normal medical imaging operations).

The array 1512 can be divided into a plurality of individual cells 1522 that can be arranged rectilinearly in columns and rows. As will be understood to those of ordinary skill in the art, the orientation of the columns and rows is arbitrary, however, for clarity of description it will be assumed that the rows extend horizontally and the columns extend vertically.

In exemplary operations, the rows of cells 1522 can be scanned one (or more) at a time by scanning circuit 1528 so that exposure data from each cell 1522 can be read by read-out circuit 1530. Each cell 1522 can independently measure an intensity of radiation received at its surface and thus the exposure data read-out can provide one pixel of information in an image 1524 to be displayed on a display 1526 normally viewed by the user. A bias circuit 1532 can control a bias voltage to the cells 1522.

Each of the bias circuit 1532, the scanning circuit 1528, and the read-out circuit 1530 (e.g., Read Out Integrated Circuits (ROICs)), can communicate with an acquisition control and image processing circuit 1534 that can coordinate operations of the circuits 1530, 1528 and 1532, for example, by use of an electronic processor (not shown). The acquisition control and image processing circuit 1534, can also control the examination procedure, and the X-ray tube 1514, turning it on and off and controlling the tube current and thus the fluence of X-rays in beam 1516 and/or the tube voltage and hence the energy of the X-rays in beam 1516.

The acquisition control and image processing circuit 1534 can provide image data to the display 1526, based on the exposure data provided by each cell 1522. Alternatively, acquisition control and image processing circuit 1534 can manipulate the image data, store raw or processed image data (e.g., at a local or remotely located memory) or export the image data.

Examples of image sensing elements used in image sensing arrays 1512 include various types of photoelectric conversion devices (e.g., photosensors) such as photodiodes (P-N or PIN diodes), photo-capacitors (MIS), or photoconductors. Examples of switching elements used for signal read-out include MOS transistors, bipolar transistors, FETs, TFTs or switch components.

In an exemplary hydrogenated amorphous silicon (a-Si:H) based indirect flat panel imager, incident X-ray photons are converted to optical photons, which can be subsequently converted to electron-hole pairs within a-Si:H n-i-p photodiodes. The pixel charge capacity of the photodiodes can be a product of the bias voltage and the photodiode capacitance. In general, a reverse bias voltage is applied to the bias lines to create an electric field (e.g., and hence a depletion region) across the photodiodes and enhance charge collection efficiency. The image signal can be integrated by the photodiodes while the associated TFTs are held in a non-conducting (“off”) state, for example, by maintaining the gate lines at a negative voltage. A radiographic imaging array can be read out by sequentially switching rows of the TFTs to a conducting state using TFT gate control circuitry. When a row of pixels is switched to a conducting (“on”) state, for example by applying a positive voltage to the corresponding gate line, charge from those pixels can be transferred along data lines and integrated by external charge-sensitive amplifiers. After data is read out, the row can then be switched back to a non-conducting state, and the process is repeated for each row until the entire array has been read out. The signal outputs from the external charge-sensitive amplifiers can be transferred to an analog-to-digital converter (ADC) by a parallel-to-serial multiplexer, subsequently yielding a digital image.

The imaging mode described above applies to static radiographic imaging applications, in which isolated single exposures are obtained. A second operating mode would apply to dynamic imaging applications, in which the radiographic exposure is continuous, such as fluoroscopy. In this operating mode the photodiode reset (a) and the exposure period (b) may be eliminated. The photodiodes are continuously exposed and the charge readout is also performed continuously, with the readout also serving to reset both photodiode and the capacitor.

Certain exemplary embodiments of DR detector methods and/or apparatus for charge compensation described herein can provide various advantages. For example, exemplary embodiments of DR detector methods and/or apparatus for charge compensation can provide multiple charge injection circuits that can temporally cancel charge injection to readout circuits resulting from positive (and/or negative) transitions of gate lines for pixel signal readout. In certain exemplary embodiments, DR detector imaging array methods and/or apparatus can provide variable charge injection levels (e.g., Voltage or Capacitance), variable Tau (e.g., Resistance or Capacitance), and/or Multiple Circuits or Single Circuit that can provide multi-charge injection with staggered timing (e.g., using Voltage and/or Capacitance Steps). In certain exemplary embodiments, DR detector imaging array methods and/or apparatus can provide Charge injection compensation on ROIC on Mask block basis. Further, certain exemplary embodiments, DR detector imaging array methods and/or apparatus can provide voltage reset offset in readout circuits (e.g., ROICs). In certain exemplary embodiments, at least one charge compensation circuit can be coupled to a corresponding data line (e.g., at both sides of the pixels, between the pixels and the signal sensing circuit), near a terminal of the signal sensing circuit, in the signal sensing circuit (e.g., at a non-inverting terminal, an inverting terminal or an output of a operational amplifier) or at the signal sensing circuit. In certain exemplary embodiments, at least one charge compensation circuit can be coupled to set an initial condition (e.g., at the CSA) for integration of the imaging array.

Exemplary embodiments herein can be applied to digital radiographic imaging panels that use an array of pixels comprising an X-ray absorbing photoconductor and a readout circuit (e.g., direct detectors). Since the X-rays are absorbed in the photoconductor, no separate scintillating screen is required.

It should be noted that while the present description and examples are primarily directed to radiographic medical imaging of a human or other subject, embodiments of apparatus and methods of the present application can also be applied to other radiographic imaging applications. This includes applications such as non-destructive testing (NDT), for which radiographic images may be obtained and provided with different processing treatments in order to accentuate different features of the imaged subject.

In certain exemplary embodiments, digital radiographic imaging detectors can include thin-film elements such as but not limited to thin-film photosensors and thin-film transistors. Thin film circuits can be fabricated from deposited thin films on insulating substrates as known to one skilled in the art of radiographic imaging. Exemplary thin film circuits can include amorphous-silicon devices such as a-Si PIN diodes, Schottky diodes, MIS photocapacitors, and be implemented using amorphous semiconductor materials, polycrystalline semiconductor materials such as silicon, or single-crystal silicon-on-glass (SiOG). Certain exemplary embodiments herein can be applied to digital radiographic imaging arrays where switching elements include thin-film devices including at least one semiconductor layer. Certain exemplary embodiments herein can be applied to digital radiographic imaging arrays where the DR detector is a flat panel detector, a curved detector or a detector including a flexible imaging substrate.

Exemplary embodiments according to the application can include various features described herein (individually or in combination).

Certain exemplary embodiments of DR detector methods and/or apparatus for charge compensation can include an imaging device mounted inside a housing, the imaging device including a plurality of pixels, each pixel including at least one electrically chargeable photosensor and at least one thin-film transistor, a bias control circuit to provide a bias voltage to the photosensors for a portion of the imaging array, an address control circuit to control gate lines, where each of the gate lines is configured to extend in a first direction and is coupled to a plurality of pixels in the portion of the imaging array, a signal sensing circuit connected to data lines, where each of the data lines is configured to extend in a second direction and is coupled to at least two pixels in the portion of the imaging array, and at least one charge compensation circuit configured to provide a compensation charge injection including temporal cancelation of gate line charge injection. In one exemplary embodiment, the at least one charge compensation circuit is coupled to the data lines and/or to the sensing circuit (e.g., ROIC, CSA). In one exemplary embodiment, the at least one charge compensation circuit includes first charge injection using a first circuit time constant and second charge injection using a second circuit time constant. In one exemplary embodiment, the at least one charge compensation circuit is configured to provide the compensation charge injection including charge injection using a first RC network and charge injection using a second RC network coupled to the data lines. In one exemplary embodiment, the at least one charge compensation circuit includes a first charge injection corresponding to a gate line to data line capacitance and a second charge injection corresponding to gate line to photosensor capacitance into a corresponding data line. In one exemplary embodiment, the at least one charge compensation circuit is configured to provide the compensation charge injection including a delay corresponding to charge injection through the at least one TFT into a corresponding data line.

Certain exemplary embodiments of DR detector methods and/or apparatus for charge compensation can include an imaging device mounted inside a housing on an insulating substrate, the imaging device including a plurality of pixels, each pixel including at least one electrically chargeable photosensor and at least one thin-film transistor, an address control circuit to control scan lines, where each of the scan lines is configured to extend in a first direction and is coupled to a plurality of pixels in the portion of the imaging array, a signal sensing circuit connected to data lines, where each of the data lines is configured to extend in a second direction and is coupled to at least two pixels in the portion of the imaging array, and at least one charge compensation circuit coupled to a first block of the imaging device and a second block of the imaging device, where the charge compensation circuit is configured to provide a first compensation charge injection for the first block and a second charge compensation injection for the second block, where the first compensation charge injection is different from the second compensation charge injection. In one exemplary embodiment, the at least one charge compensation circuit includes a first charge compensation circuit coupled to said first block and a first ROIC, and a second charge compensation circuit coupled to said second block and a second ROIC, where the first block is connected to a first ROIC and the second block is connected to a second ROIC. In one exemplary embodiment, the first block corresponds to a first exposure of a mask used to form the imaging array and the second block corresponds to a second exposure of the mask. In one exemplary embodiment, the first block is corresponds to a first step of a mask used to form the imaging array and the second block corresponds to a second step of the mask used to form the imaging array.

Certain exemplary embodiments of DR detector methods and/or apparatus for charge compensation can include an imaging array including a plurality of pixels arranged in rows and columns, each pixel comprising a thin-film photosensor configured to generate a signal based upon radiation received, a method including operating the imaging array in a first mode, the first mode including providing a first reference voltage using a first reference voltage line to a portion of the imaging array, commanding a multiplexer circuit to selectively couple selected pixels of the portion of the imaging array to selectively enabled gate lines, and reading signals from the selected pixels of the portion of the imaging array using enabled data lines; and providing a compensation charge injection for temporal cancelation of gate line charge injection to a plurality of enabled data lines.

In exemplary embodiments, providing a compensation charge injection includes temporally adjusting sensor charge compensation charge injection and data line charge compensation charge injection.

Certain exemplary embodiments of DR detector methods and/or apparatus for charge compensation can include a plurality of pixels arranged in rows and columns, each pixel including a thin-film photosensor configured to generate a signal based upon radiation received, one method embodiment including operating the imaging array in a first mode, the first mode including providing a first reference voltage (bias) using a first reference voltage line to a portion of the imaging array, resetting a signal sensing circuit before receiving pixel signal output, where resetting the signal sensing circuit includes applying a non-zero voltage or charge across a feedback capacitor for an operational amplifier while maintaining a reference voltage at an input and output of the operational amplifier, commanding a multiplexer circuit to selectively couple selected pixels of the portion of the imaging array to selectively enabled gate lines, and reading signals from the selected pixels of the portion of the imaging array using enabled data lines.

In exemplary embodiments, the feedback capacitor is selectively disconnected from the output of the operational amplifier during the resetting. Exemplary embodiments can further include providing a compensation charge injection for temporal cancelation of gate line charge injection to a plurality of enabled data lines.

For certain exemplary embodiments, the at least one charge compensation circuit includes a first charge compensation circuit coupled to each data line at a first side of the at least two pixels; and a second charge compensation circuit coupled to said each data line at a second side of the at least two pixels, between the at least two pixels and the signal sensing circuit or at the signal sensing circuit. In exemplary embodiments, the at least one charge compensation circuit includes a plurality of variable charge injection levels. In exemplary embodiments, the plurality of charge injection levels include variable voltage levels or variable capacitance levels. In exemplary embodiments, the plurality of charge injection levels include a plurality of selectable voltage levels or a plurality of selectable capacitance levels, where the selectable voltage levels are selectable by a plurality of switches. In exemplary embodiments, the at least one charge compensation circuit is configured to provide a plurality of variable charge injection delays.

For certain exemplary embodiments, the at least one charge compensation circuit includes a plurality of charge injection levels being a plurality of selectable voltage levels or a plurality of selectable capacitance levels, where the selectable voltage levels are selectable by a plurality of switches that can be preset by registers. For certain exemplary embodiments, the at least one charge compensation circuit includes a plurality of variable charge injection delays, where the plurality of variable charge injection delays comprise variable resistance time delays, variable capacitance time delays, or RC networks time delays. In exemplary embodiments, the plurality of variable charge injection delays are selectable by a plurality of switches.

For certain exemplary embodiments, the at least one charge compensation circuit includes a plurality of charge compensators, where a selected charge compensator or a selected combination of charge compensators are selectable by a plurality of switches. In exemplary embodiments, the plurality of charge compensators each provide a different charge compensation injection tau.

For certain exemplary embodiments, the at least one charge compensation circuit includes a single charge compensation circuit configured to provide a plurality of prescribed charge injections that each provide a different charge compensation injection taus. In exemplary embodiments, the different charge compensation injection taus are selectable by a plurality of switches.

In exemplary embodiments, at least one photosensor and at least one the thin-film transistor includes at least one semiconductor layer, and that at least one semiconducting layer comprises amorphous silicon, micro-crystalline silicon, poly-crystalline silicon, organic semiconductor, and metal oxide semiconductors (e.g., IGZO). In exemplary embodiments, the signal sensing circuits include at least one of an analog to digital conversion circuit, an analog amplifier, a charge to voltage conversion circuit, a current to voltage conversion circuit, an analog multiplexer, a digital multiplexer, a data communication circuit, or semiconductor integrated circuits attached to the data lines. In exemplary embodiments, the detector includes a conversion screen configured to convert first radiation of one or multiple wavelength range into second different radiation of one or multiple wavelength range proximate to a plurality of pixels. In exemplary embodiments, the detector includes a radiation source for generating radiation. In exemplary embodiments, the detector is a flat panel detector, a curved detector or a detector including a flexible imaging substrate, and can be a portable detector or battery powered.

Embodiments of radiographic imaging systems and/methods described herein contemplate methods and program products on any computer readable media for accomplishing its operations. Certain exemplary embodiments accordingly can be implemented using an existing computer processor, or by a special purpose computer processor incorporated for this or another purpose or by a hardwired system.

Consistent with exemplary embodiments, a computer program with stored instructions that perform on image data accessed from an electronic memory can be used. As can be appreciated by those skilled in the image processing arts, a computer program implementing embodiments herein can be utilized by a suitable, general-purpose computer system, such as a personal computer or workstation. However, many other types of computer systems can be used to execute computer programs implementing embodiments, including networked processors. Computer program for performing method embodiments or apparatus embodiments may be stored in various known computer readable storage medium (e.g., disc, tape, solid state electronic storage devices or any other physical device or medium employed to store a computer program), which can be directly or indirectly connected to the image processor by way of the internet or other communication medium. Those skilled in the art will readily recognize that the equivalent of such a computer program product may also be constructed in hardware. Computer-accessible storage or memory can be volatile, non-volatile, or a hybrid combination of volatile and non-volatile types.

It will be understood that computer program products implementing embodiments of this application may make use of various image manipulation algorithms and processes that are well known. It will be further understood that computer program products implementing embodiments of this application may embody algorithms and processes not specifically shown or described herein that are useful for implementation. Such algorithms and processes may include conventional utilities that are within the ordinary skill of the image processing arts. Additional aspects of such algorithms and systems, and hardware and/or software for producing and otherwise processing the images or co-operating with computer program product implementing embodiments of this application, are not specifically shown or described herein and may be selected from such algorithms, systems, hardware, components and elements known in the art.

Priority is claimed from commonly assigned, copending U.S. provisional patent applications Ser. No. 61/720,092, filed Oct. 30, 2012, entitled “CHARGE INJECTION COMPENSATION METHODS AND APPARATUS FOR DIGITAL RADIOGRAPHIC DETECTORS”, in the name of Mark E. Shafer et al., the disclosure of which is incorporated by reference.

While the invention has been illustrated with respect to one or more implementations, alterations and/or modifications can be made to the illustrated examples without departing from the spirit and scope of the appended claims. In addition, while a particular feature of the invention can have been disclosed with respect to only one of several implementations/embodiments, such feature can be combined with one or more other features of the other implementations/embodiments as can be desired and advantageous for any given or particular function. The term “at least one of” is used to mean one or more of the listed items can be selected. The term “about” indicates that the value listed can be somewhat altered, as long as the alteration does not result in nonconformance of the process or structure to the illustrated embodiment. Finally, “exemplary” indicates the description is used as an example, rather than implying that it is an ideal. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A digital radiographic area detector comprising:
a housing configured to include an upper surface, a lower surface, and side surfaces to connect the upper surface and the lower surface;
an imaging device mounted inside the housing, the imaging device comprising a plurality of pixels, each pixel comprising at least one electrically chargeable photosensor and at least one thin-film transistor;
a bias control circuit to provide a bias voltage to the photosensors for a portion of the imaging array;
an address control circuit to control gate lines, where each of the gate lines is configured to extend in a first direction and is coupled to a plurality of pixels in the portion of the imaging array;
a signal sensing circuit connected to data lines, where each of the data lines is configured to extend in a second direction and is coupled to at least two pixels in the portion of the imaging array; and
at least one charge compensation circuit coupled to the data lines, where the charge compensation circuit is configured to provide a compensation charge injection including temporal cancelation of gate line charge injection.

2. The digital radiographic area detector of claim 1, where the at least one charge compensation circuit is configured to provide the compensation charge injection including first charge injection using a first circuit time constant and second charge injection using a second circuit time constant.

3. The digital radiographic area detector of claim 1, where the at least one charge compensation circuit comprises a plurality of charge compensation circuits each configured to provide at least one of a plurality of variable charge injection levels, where the plurality of charge injection levels are selectable voltage levels or selectable capacitance levels, where the plurality of selectable charge injection levels are selectable by a plurality of switches.

4. The digital radiographic area detector of claim 1, where the at least one charge compensation circuit comprises a single charge compensation circuit configured to provide a plurality of variable charge injection delays, where the plurality of variable charge injection delays comprise variable resistance time delays or variable capacitance time delays, where the plurality of variable charge injection delays are selectable by a plurality of switches.

5. The digital radiographic area detector of claim 1, where the at least one charge compensation circuit is configured to provide the compensation charge injection including a first charge injection corresponding to a gate line to data line capacitance and a second charge injection corresponding to gate line to photosensor capacitance into a corresponding data line, where the at least one charge compensation circuit comprises:
a first charge compensation circuit coupled to said each of the data line before the at least two pixels; and
a second charge compensation circuit coupled between the at least two pixels and the signal sensing circuit.

6. The digital radiographic area detector of claim 1, where the signal sensing circuit is reset before receiving pixel signal output, where the reset signal sensing circuit comprises applying a non-zero voltage or charge applied across a feedback capacitor for an operational amplifier while a reference voltage is maintained at an input and output of the operational amplifier.

7. A digital radiographic area detector comprising:
a housing configured to include an upper surface, a lower surface, and side surfaces to connect the upper surface and the lower surface;
an insulating substrate inside the housing;
an imaging device mounted inside the housing on the insulating substrate, the imaging device comprising a plurality of pixels, each pixel comprising at least one electrically chargeable photosensor and at least one thin-film transistor;
an address control circuit to control scan lines, where each of the scan lines is configured to extend in a first direction and is coupled to a plurality of pixels in the portion of the imaging array;
a signal sensing circuit connected to data lines, where each of the data lines is configured to extend in a second direction and is coupled to at least two pixels in the portion of the imaging array; and
at least one charge compensation circuit coupled to a first block of the imaging device and a second block of the imaging device, where the charge compensation circuit is configured to provide a first compensation charge injection for the first block and a second charge compensation injection for the second block, where the first compensation charge injection is different from the second compensation charge injection.

8. The digital radiographic area detector of claim 7, where the charge compensation circuit comprises:
a first charge compensation circuit coupled to said first block and a first ROIC; and
a second charge compensation circuit coupled to said second block and a second ROIC, where the first block is connected to a first ROIC and the second block is connected to a second ROIC, and where the first block is corresponds to a first exposure of a mask used to form the imaging array and the second block corresponds to a second exposure of the mask.

9. A method of operating a digital radiographic detector, the radiographic detector including an imaging array comprising a plurality of pixels arranged in rows and columns, each pixel comprising a thin-film photosensor configured to generate a signal based upon radiation received, the method comprising:
operating the imaging array in a first mode, the first mode comprising,
providing a first reference voltage (bias) using a first reference voltage line to a portion of the imaging array,
commanding a multiplexer circuit to selectively couple selected pixels of the portion of the imaging array to selectively enabled gate lines, and
reading signals from the selected pixels of the portion of the imaging array using enabled data lines; and
providing a compensation charge injection for temporal cancelation of gate line charge injection to a plurality of enabled data lines, where providing a compensation charge injection includes temporally adjusting sensor charge compensation charge injection and data line charge compensation charge injection.

10. The method of claim 9, further comprising,
resetting a signal sensing circuit before receiving pixel signal output, where resetting the signal sensing circuit comprises applying a non-zero voltage or charge across a feedback capacitor for an operational amplifier while maintaining a reference voltage at an input and output of the operational amplifier.

11. A digital radiographic detector comprising:
a housing comprising upper and lower substantially rectangular and parallel surfaces, and a plurality of side surfaces coupled to the upper and lower surfaces, wherein the upper surface, the lower surface, and the side surfaces enclose an interior of the housing;
an imaging device mounted within the interior of the housing, the imaging device comprising a plurality of pixels, each of the pixels comprising at least one photosensor and at least one thin-film transistor, each of the pixels connected to one of a plurality of gates lines and to one of a plurality of data lines;
a bias circuit connected to at least some of the photosensors to provide a bias voltage to said at least some of the photosensors;
an address control circuit connected to the plurality of gate lines;
a signal sensing circuit connected to the plurality of data lines; and
a charge compensation circuit coupled to the plurality of data lines to provide a compensation charge thereto equivalent to a gate line charge.

12. The digital radiographic area detector of claim 11, wherein the charge compensation circuit is configured to provide the compensation charge according to a first circuit time constant and to provide a second compensation charge according to a second time constant.

13. The digital radiographic area detector of claim 11, wherein the charge compensation circuit is configured to provide a selectable amount of electrical charge.

14. The digital radiographic area detector of claim 11, wherein the charge compensation circuit is configured to provide the compensation charge at a selectable time delay controlled by a variable resistance or a variable capacitance.

15. The digital radiographic area detector of claim 11, wherein the charge compensation circuit is configured to provide the compensation charge in response to a capacitance between a corresponding gate line and a data line and to provide a charge injection corresponding to a capacitance between a gate line and a photosensor, the charge injection delivered to a data line connected to the photosensor.

16. The digital radiographic area detector of claim 11, further comprising an op amp connected to the plurality of pixels, wherein the signal sensing circuit is configured to apply a voltage across the op amp while a reference voltage is maintained at an input and output of the op amp.

17. The digital radiographic area detector of claim 13, wherein the imaging device is configured into a first block and a second block, the charge compensation circuit is configured to provide a first selectable amount of electrical charge to the first block and a second selectable amount of electrical charge to the second block, where the first amount of electrical charge is different from the second amount of electrical charge.

18. The digital radiographic area detector of claim 17, wherein the first block includes a first ROIC, the second block includes a second ROIC, and wherein the first block corresponds to a first exposure of a mask used to form the imaging device and the second block corresponds to a second exposure of the mask used to form the imaging device.

19. The digital radiographic area detector of claim 11, further comprising a multiplexer configured to couple selected ones of the plurality of pixels to their corresponding gate line, wherein the charge compensation circuit provides a compensation charge over the data lines connected to said ones of the plurality of pixels coupled to their corresponding gate line by the multiplexer.
